(19) United States
(12) Patent Application Publication
(10) Pub. No.: US 2026/0170731 A1
(43) Pub. Date: Jun. 18, 2026

(54) CLOTHING GENERATION USING GENERATIVE ARTIFICIAL INTELLIGENCE MODEL

(71) Applicant: Stability AI Ltd, London (GB)

(72) Inventor: Dennis Niedworok, Berlin (DE)

(73) Assignee: Stability AI Ltd, London (GB)

(21) Appl. No.: 19/418,826

(22) Filed: Dec. 12, 2025

Related U.S. Application Data
(60) Provisional application No. 63/733,265, filed on Dec. 12, 2024.

(51) Int. Cl. G06T 11/60; G06N 3/0895

(52) U.S. Cl. CPC G06T 11/60; G06N 3/0895

(57) ABSTRACT

Techniques include receiving a first image of a subject, a second image of a garment, and a text prompt. The techniques further include generating, using a reverse diffusion model and based at least in part on a noised input, the first image, the second image, and the text prompt, a first output image that represents the subject wearing the garment, wherein the reverse diffusion model generates an embedding of the first output image based at least in part on the noised input.

### CROSS REFERENCE TO RELATED APPLICATIONS

This application claims the benefit of and priority to U.S. Provisional Application No. 63/733,265, filed Dec. 12, 2024, and titled “Clothing Visualization Using Generative Artificial Intelligence Model,” the content of which is herein incorporated by reference in its entirety for all purposes.

### BACKGROUND

Computing devices and online services are used to provide different virtualization services. virtualization services may includer services for generating images showing how real-world objects may appear when combined together. Traditional methods for virtual apparel try-on have been limited by manual image editing, static overlays, or rudimentary compositing techniques that fail to capture the complexity and realism of actual garment fit, pose, and/or interaction with the human form.

### BRIEF DESCRIPTION OF THE DRAWINGS

Features, embodiments, and advantages of the present disclosure are better understood when the following Detailed Description is read with reference to the accompanying drawings.

FIG. 1 is a block diagram illustrating an example clothing visualization system, according to certain embodiments.

FIG. 2 is a block diagram illustrating an example first image generation system, according to certain embodiments.

FIG. 3 is a block diagram illustrating an example second image generation system, according to certain embodiments.

FIG. 4 is a block diagram illustrating an example image upscaling system, according to certain embodiments.

FIG. 5 is a block diagram illustrating an example reverse diffusion model architecture, according to certain embodiments.

FIG. 6 shows an example method 600 of using a clothing visualization system (e.g., clothing visualization system 108 described above), according to certain embodiments of the present disclosure.

FIG. 7 is a block diagram illustrating an exemplary computer system, according to certain embodiments.

### DETAILED DESCRIPTION

Certain embodiments described herein are directed at improving object interaction simulations. Embodiments may improve computer simulations that simulate how real objects interact without requiring the objects to interact in the real world. In an example, how garments interact with subjects (e.g., people, animals, virtual avatars, or other objects) is simulated using image processing techniques. Garments on users are an example use case described herein in the interest of clarity of explanation but other object interactions may also be simulated.

In an example embodiment, a clothing visualizatin system can enable a garment image (representing articles of clothing such as shirts, jackets, or accessories) to be received and used with an image of the subject. The system may further accept prompts or instructions (e.g., as textual inputs and/or as masks) which can guide and control how the garment is applied to regions of subject image.

Certain embodiments may support manual and/or automated workflows. For instance, masks provided at a user interface (e.g., touchscreen) can be used to specify garment placement for precise control. In some instances, segmentation models that interpret natural language prompts (e.g., “apply to upper torso”) may be used to generate a mask. Certain embodiments enable the application of multiple garments (e.g., sequentially or simultaneously) through the use of compound masks and/or iterative processing. Additionally, the clothing visualizatin system may incorporate depth estimation models that generate depth maps of the subject image, which can serve to condition generative processes and ensure that garments conform accurately to the three-dimensional shape and/or pose of the subject. The conditioning can enable generated images with natural perspective, shading, and/or fit, regardless of the subject's orientation and/or a background.

The clothing visualizatin system may be divided into multiple stages. An initial stage may apply the garment to a masked region of the subject image, guided by conditioning. A subsequent stage may be performed to refine the image generated from the initial stage. The second stage may perform refinement, blending, and upscaling, leveraging composite images and latent masking systems to enhance visual fidelity and/or remove artifacts. The first stage and/or the second stage enable the clothing visualizatin system to generate an image of a garment on the subject that was not on the subject in the original image of the subject.

The use of depth-conditioned generative models addresses challenges in garment fit and realism, allowing for accurate simulation even with varied poses and/or non-standard images. The modularity of the system supports rapid extensibility to new garment types, model representations, and interaction modalities. Furthermore, the ability to process and blend multiple garments, as well as to refine outputs through latent-space masking, enables complex, layered virtual try-on scenarios.

Computers can be programmed to provide, as a function, virtualization of objects as output. Embodiments described herein improve such the function by implementing a workflow enabling input of a subject image and a garment image, with the additional option of specifying a masks to define the precise region for garment placement on the subject. By doing so, the system enables customized, context-aware, and accurate placement of virtual garments, on a subject (e.g., virtualization of garment objects). The system can use iterative refinement and/or multi-stage processing, such as upscaling and blending passes. Embodiments can result in improvements to the virtualization function of computers by enhancing the realism, flexibility, and adaptability of outputs, overcoming the limitations of prior systems that lacked fine-grained control over garment localization or relied solely on automatic, non-interactive overlays. Embodiments can result in improvements to the virtualization function of computers by enabling diverse inputs to be used to generate object virtualization output. As a result, the described embodiments enable higher-quality (e.g., more accurate virtual object representations) and diversified object virtualization.

### System Architectures

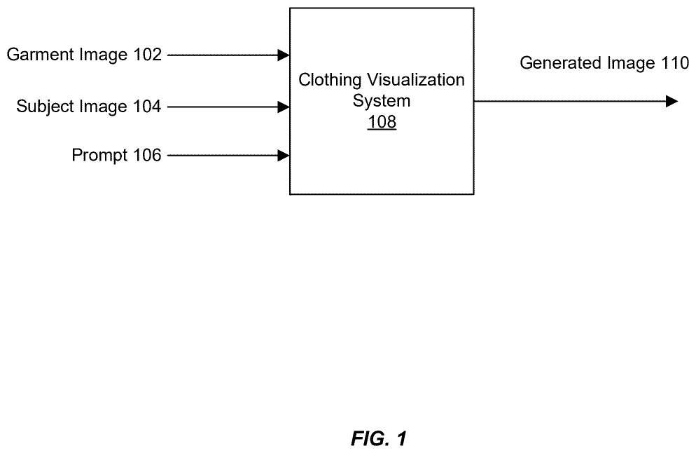

The clothing visualization system and/or components included in the clothing visualization system are illustrated in FIGS. 1-5 described below in further detail.

### A. Clothing Visualization System

FIG. 1 is a block diagram illustrating an example clothing visualization system 108, according to certain embodiments. The clothing visualization system 108 (an example of a garment visualization system) may output a generated image 110 based on (e.g., based at least in part on) a garment image 102, a subject image 104, and/or a prompt 106.

The garment image 102 may be received from memory, a remote device, a local device, and/or a user device, etc. For example, the garment image 102 may have been received after an indication (e.g., selection, upload, etc.) of the garment image 102 was received at a user interface of another device (e.g., a user device). The garment image 102 may be represented by an image file such as Portable Network Graphics (PNG) or Joint Photographic Experts Group (JPEG). The garment image 102 may include an image of a garment. A garment may be an object that can be worn. A garment may be worn by a human, an animal (e.g., dog, cat, goat, etc.), a virtual avatar, or another subject. A garment may include one or more colors, materials, and/or textures. A garment may have an associated size (e.g., small, medium, large, 34W, 32L, etc.). Examples of garments include but are not limited to a t-shirt, a button up shirt, pants, a necklace, a bracelet, a ring, a watch, a hat, glasses, etc. The garment image 102 may depict a garment from any angle. The garment image 102 may represent a single garment.

The subject image 104 may be received from memory, a remote device, a local device, and/or a user device, etc. For example, the subject image 104 may be received after an indication (e.g., selection, upload, etc.) of the subject image 104 was received at a user interface of another device (e.g., a user device). The subject image 104 may include an image of a subject. A subject may traditionally wear garments (e.g., a human, a dog, etc.) but need not be. The subject image 104 may be represented by an image file such as Portable Network Graphics (PNG) or Joint Photographic Experts Group (JPEG). The subject image 104 may depict the subject at any angle. The subject image 104 may represent a single subject.

The prompt 106 may be received from memory, a remote device, a local device, and/or a user device, etc. For example, the prompt 106 may have been received after an indication (e.g., selection, input, etc.) of the prompt 106 was received at a user interface of another device (e.g., a user device). The prompt 106 may be represented by text such as natural language text (e.g., “upper torso”). In certain embodiments, the prompt 106 is generated based on the garment image 102. The prompt 106 may include and/or serve as an instruction for the clothing visualization system 108 to generate the generated image 110. The prompt 106 may detail the desired operations for use with the garment image 102 and the subject image. The prompt 106 may specify the location or region for garment placement (serving as a mask or segmentation guide). The prompt 106 may specify a type, a style, and/or a characteristic of the garment of to be applied to the subject. The prompt 106 may specify additional parameters such as background or model identity.

In certain embodiments, the prompt 106 may include compound instructions, such as instructions specifying multiple garment placements and/or detailing interactions between different garment images (e.g., “apply a shirt and a hat to the subject,” “place a flower graphic on the shirt before applying it to the subject”).

The clothing visualization system 108 may include a set of machine learning models (e.g., a reverse diffusion model) used to generate the generated image based on the garment image 102, the subject image 104, and/or the prompt 106. The clothing visualization system 108 may perform processing to generate a first image based on the input to the clothing visualization system 110. The clothing visualization system 110 may generate an upscaled image from the first image. The generated image 110 may include the first image or the upscaled image.

The generated image 110 may be output from the clothing visualization 108 system based on the inputs to the clothing visualization system 108. The generated image 110 may include an image of the subject represented by the subject image 104 wearing the garment represented by the garment image 102. The generated image 110 may be a same image file type (e.g., Portable Network Graphics (PNG), Joint Photographic Experts Group (JPEG), etc.) or different image file type as the garment image 102 and/or the subject image 104. The generated image 110 may be transmitted to memory, a remote device, and/or a client device. The generated image 110 may be transmitted to a device that transmitted the garment image 102, the subject image 104, and/or the prompt 106. The generated image 110 may be presented by a user interface (e.g., a display).

### B. First Image Generation System With Supplied Mask

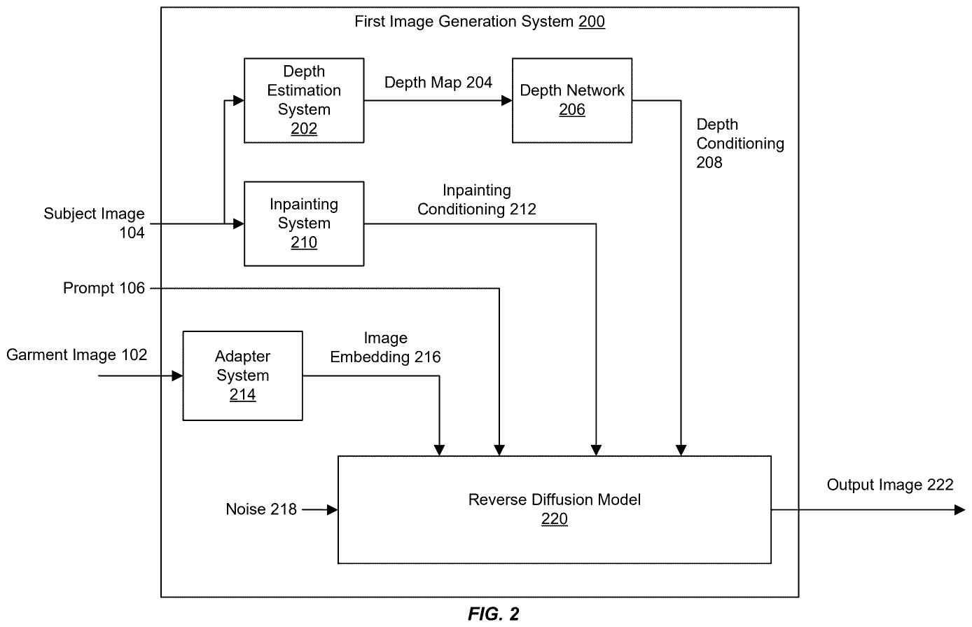

FIG. 2 is a block diagram illustrating an example first image generation system 200, according to certain embodiments. The first image generation system 200 may be included in the clothing visualization system 108 described above. The first image generation system 200 may generate and output an output image 222 (e.g., the generated image 110 described above) based on a subject image 104 (e.g., subject image 104 described above), a prompt 106 (e.g., prompt 106 described above), and a garment image 102 (e.g., garment image 102 described above). The first image generation system 200 may include a depth estimation system 202, a depth network 206, an inpainting system 210, an adapter system 214, and/or a reverse diffusion model 220.

The subject image 104 may include the subject image 104 described above with respect to FIG. 1. The subject image 104 may include a mask. The mask may be useful for additional control of how the output image 222 is generated. The mask may be used to inform the generation of the output image 222. The mask may be presented as an overlay included in the subject image 104. The mask may be represented using metadata of the subject image 104. The mask may include a binary or multi-channel overlay superimposed onto at least a portion of the subject image 104 to designate a region where modifications (such as garment application and/or garment replacement) should occur. The mask may be represented using an array or matrix corresponding to pixels the subject image, where designated values (such as 1/0 or color-coded channels) indicate masked versus unmasked regions.

The mask may have been generated based on input from a user interface (e.g., input that indicates pixels of the subject image to mask) The mask may have been generated using a set of segmentation models (such as Segment Anything and/or DINO). Generating a mask is described in further detail herein (e.g., with respect to second image generation system 300).

This mask can be used for subsequent image processing steps, such as inpainting, blending, and/or diffusion. For example, when a user wishes to apply a T-shirt to a subject wearing a long-sleeve shirt, the mask may be drawn to cover only the torso region, instructing the first image generation system 200 to restrict garment application to the masked area and replace the underlying clothing accordingly. The mask can indicate an area of the subject image where inpainting or garment overlay will occur so that the specified portion of the subject image is modified while preserving the other portions subject image (e.g., other garment's worn by the subject).

In certain embodiments, the subject image 104 includes multiple masks. Each mask may be associated with a garment included in one or more garment images. Multiple masks may enable the first image generation system 200 to be used to generate the output image 222 that includes multiple garments that were not originally shown on the subject included in the subject image 104.

The prompt 106 may include the prompt 106 described above with respect to FIG. 1. The prompt 106 can be transmitted to the reverse diffusion model 220 to influence the generation of the output image 222. The reverse diffusion model 220 may generate a prompt embedding using a text encoder and use the prompt embedding to influence the generation of the output image 222. In certain embodiments, the prompt 106 may be transmitted to a text encoder to generate the prompt embedding before the prompt embedding is transmitted to the reverse diffusion model 220.

The garment image 102 may include the garment image 102 described above with respect to FIG. 1. The garment image 102 may be transmitted to the adapter system 214.

The depth estimation system 202 may generate a depth indication (e.g., a depth map). The depth indication may represent the depth of the subject represented by the subject image 104. The depth indication may indicate the depth represented by one or more pixels of the subject image 104. The depth estimation system 202 may include a depth estimation model (e.g., monocular depth estimation (MDE), Fast Monocular Depth Estimation with Flow Matching (DepthFM), etc.) that can generate the depth map 204 based on the subject image 104. The depth map 204 may represent spatial geometry and three-dimensional structure of the subject depicted in the subject image 104. The depth map 204 can provide pixel-level information about the relative distances and contours of various regions represented within the subject image 104, such as a torso of the subject, arms of the subject, or other parts of the subject. The depth map 204 enables representation of a three-dimensional (3D) structure of the subject and enables guidance of the placement and blending of the garment image 102 onto the subject. The depth map 204 can enable the garment applied to the subject image 104 to conform to the contours and perspective of the subject (e.g., applied in a manner that conforms with the subject's physical dimensions and orientation). The depth estimation system 202 may transmit the depth indication to the depth network 206.

The depth network 206 may receive the depth indication from the depth estimation system 202. The depth network 206 may include a neural network. The depth network 206 may include a ControlNet. The depth network 206 can enable the reverse diffusion model 220 to be guided. The depth network 206 can generate control signals (e.g., depth conditioning) that can influence the behavior and output of the reverse diffusion model 220. The depth network 206 may generate depth conditioning 208 based on the depth indication. The depth conditioning 208 may include a high dimensionality (e.g., embedded) representation of the depth indication. The depth network 206 can use the depth indication to influence generation of the output image 222 by providing detailed spatial or structural relationships represented by depth conditioning 208.

The depth conditioning 208 can enable the diffusion model 220 to align the garment with the subject's pose, account for occlusions, and/or maintain proper shading and perspective. The depth conditioning 208 can enable a more realistic depiction of the garment on the subject (e.g., with natural transitions and consistent visual output, even when the model is depicted at complex angles or in dynamic poses). The depth conditioning 208 can be transmitted from the depth network 206 to the reverse diffusion model 220. The depth conditioning 208 may be represented by an embedding (e.g., in a vector space).

The inpainting system 210 may receive subject image 104 (e.g., including the mask). The inpainting system 210 may receive the mask and the subject image 104 without the mask. The inpainting system 210 may include a machine learning model (e.g., PyTorch, a ControlNet trained on inpainting tasks). The machine learning model may generate an embedding of the subject image 104. The embedding of the subject image 104 may be used as inpainting conditioning 212 to be transmitted to the reverse diffusion model 220 and used by the reverse diffusion model 220 for generating the output image 222. The inpainting conditioning 212 may represent the mask, the masked portions of the subject image 104, and/or the unmasked portions of the subject image 104 in a high dimensional embedding/vector space. The inpainting conditioning 212 may be represented by an embedding (e.g., in a vector space).

The adapter system 214 may receive the garment image 102. The adapter system 214 may generate an image embedding 216 based on the garment image 102. The adapter system 214 may include an image-prompt (IP) adapter model that includes an image encoder. The adapter system 214 may enable the reverse diffusion model 220 to use an image (e.g., the garment image 102) as part of a set of prompts. The image embedding can enable the reverse diffusion model 220 to understand the context of the garment image 102. The image embedding can represent details of the garment image 102 that can be used to condition the reverse diffusion model 220. The image conditioning may be represented by an embedding in a vector space.

The reverse diffusion model 220 may include a stable diffusion model. The reverse diffusion model 220 may include a pretrained model. The reverse diffusion model 220 may generate the output image 222 based on inputs such as the depth conditioning 208, the inpainting conditioning 212, the image embedding 216, and/or noise 218. The noise 218 may be represented in an embedding space. The noise 218 may be randomly generated. The noise 218 may be sampled from a gaussian distribution. The reverse diffusion model 220 may iteratively remove noise from the noise embedding 218. The noise 218 may be removed based on conditioning. The conditioning may include cross conditioning. Cross conditioning can involve integrating additional information/conditions into the data generation process of the reverse diffusion model 220. Cross conditioning can enable a more controlled and/or tailored output image to be generated. The conditioning may use the depth conditioning 208, the inpainting conditioning 212, the prompt 106 (or an embedding of the prompt 106, such as a text embedding represented in vector space), and/or the image embedding 216 to influence the generation of the output image 222 from the noise 218.

In certain embodiments, a reverse diffusion model 220 is not used and instead a different type of machine learning model is used that can generate the output image 222 based on inputs such as the depth conditioning 208, the inpainting conditioning 212, the image embedding 216, and/or noise 218. In certain embodiments, the reverse diffusion model 220 generates an embedding of an image that can be decoded by a decoder model to generate the output image 222.

The output image 222 may represent the subject wearing the garment from the garment image 102. The output image 222 may be represented using an image file format such as JPEG or PNG. The output image 222 may be stored and/or transmitted. The output image 222 may be the generated image 110 described above with respect to FIG. 1.

In certain embodiments, the output image 222 is used for subsequent processing such as as input to the first image generation system 200 as a subject image 104, as input to the second image generation system 300 as subject image 104, as input to the image upscaling system 400 as subject image 104, and/or as input to the image upscaling system 400 as output image 222, etc.

### C. Clothing Visualization System Using Mask Generation

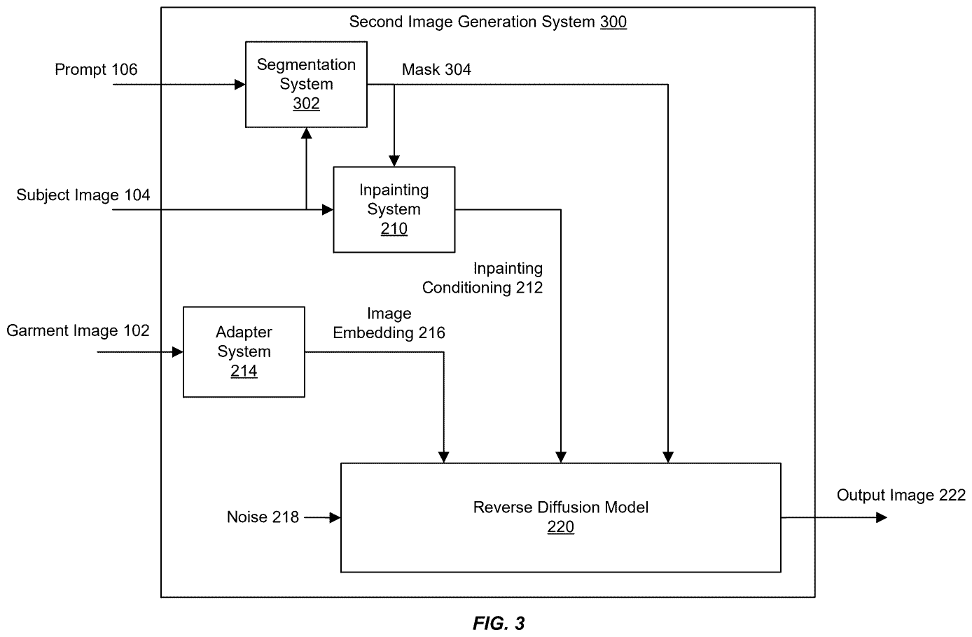

FIG. 3 is a block diagram illustrating an example second image generation system 300, according to certain embodiments. The second image generation system 300 may be included in the clothing visualization system 108 described above. The second image generation system 300 may generate output image 222 (e.g., the generated image 110 described above) based on a subject image 104 (e.g., subject image 104 described above), a prompt 106 (e.g., prompt 106 described above), and a garment image 102 (e.g., garment image 102 described above). The second image generation system 300 may include a depth estimation system (e.g., depth estimation system 202) like described above (but may not), a depth network (e.g., depth network 206) like described above (but may not), an inpainting system 210 (inpainting system 210 described above), an adapter system 214 (e.g., adapter system 214 described above), and/or a reverse diffusion model 220 (e.g., reverse diffusion model 220 described above).

The prompt may be similar to the prompt 106 described above. The subject image 104 may be similar to the subject image 104 described above. The subject image 104 of the second image generation system 300 may not include a mask. Instead, the second image generation system 300 may generate a mask 304 using the segmentation system 302 based on the prompt 106 and the subject image 104.

The segmentation system 302 may receive the prompt 106 or an embedding of the prompt generated by an encoder that processed the prompt 106 to generate the prompt embedding. The segmentation system 302 may generate the mask 304 (e.g., like the mask described above with respect to the subject image used for first image generation system 200). Like described above, the mask 304 may indicate a region of the subject image 104 where a garment is to be applied and/or replaced. Segmentation system 302 may combine information from the prompt 106 with the visual data of the subject image 104. The prompt 106 (e.g., a textual instruction such as “upper torso,” “legs,” or “chest”) may specify an intended target area for garment placement. The segmentation system 302 may interpret the prompt 106 and analyze the subject image 104 to locate and delineate the corresponding portion (e.g., body part(s)).

The segmentation system 302 may include a set of machine learning models. The set of machine learning models may include a Segment Anything Model and/or a Distillation with No Labels (DINO) model. Upon receiving the prompt 106 (or an embedding of the prompt 106) and the subject image 104, the segmentation system 302 may process the subject image 104 to generate a binary or multi-channel mask. The mask 304 may include a pixel-level overlay that highlights the specific region of interest in the subject image 104, effectively distinguishing the area to be modified from the remainder of the subject image 104 that should remain unchanged. In an example, if the prompt 106 specifies “T-shirt,” the segmentation system 302 can identify and mask 304 the portion of the subject's body corresponding to a T-shirt, even in the presence of varied poses, backgrounds, and/or existing clothing. The mask 304 generated by the segmentation system 302 may be transmitted to the inpainting system 210 and/or the reverse diffusion model 220. The mask 304 may be represented in an embedding space (e.g., a high dimensional vector space).

The inpainting system 210 may receive the subject image 104 and the mask 304. The inpainting system 210 may generate inpainting conditioning 212 based on the subject image 104 and the mask 304. The inpainting system 210 may perform processing like the inpainting system 210 described above with respect to second image generation system 200 to generate inpainting conditioning 212. Inpainting conditioning 212 may be like the inpainting conditioning 212 described above with respect to first image generation system 200. Inpainting conditioning 212 may be transmitted to the reverse diffusion model 220 to influence generation of the output image 222.

The garment image 102, the adapter system 214, and the image embedding 216 may be like the garment image 102, the adapter system 214, and the image embedding 216 respectively described above in connection with the first image generation system 200. The image embedding may be transmitted to the reverse diffusion model 220 to influence generation of the output image 222.

The reverse diffusion model 220 may be the reverse diffusion model 220 described above with respect to first image generation system 200. The reverse diffusion model 220 may generate the output image 222 based on inputs such as the mask 304, the inpainting conditioning 212, the image embedding 206, and/or noise 218 (e.g., noise 218 described above with respect to first image generation system 200). The noise 218 may be removed based on conditioning. The conditioning may include cross conditioning. The conditioning may rely on the mask 304, the inpainting conditioning 212, and/or the image embedding 216 to influence the generation of the output image 222 from the noise 218.

In certain embodiments, a reverse diffusion model 220 is not used and instead a different type of machine learning model is used that can generate the output image 222 based on inputs such as the mask 304, the inpainting conditioning 212, the image embedding 216, and/or the noise 218. In certain embodiments, the reverse diffusion model 220 generates an embedding of an image that can be decoded by a decoder model to generate the output image 222.

The output image 222 may represent the subject wearing the garment from the garment image 102. The output image 222 may be represented using an image file format such as JPEG or PNG. The output image 222 may be stored and/or transmitted. The output image 222 may be the generated image 110 described above with respect to FIG. 1.

In certain embodiments, the output image 222 is used for subsequent processing such as as input to the first image generation system 200 as a subject image 104, as input to the second image generation system 300 as subject image 104, as input to the image upscaling system 400 as subject image 104, and/or as input to the image upscaling system 400 as output image 222, etc.

### D. Image Upscaling System

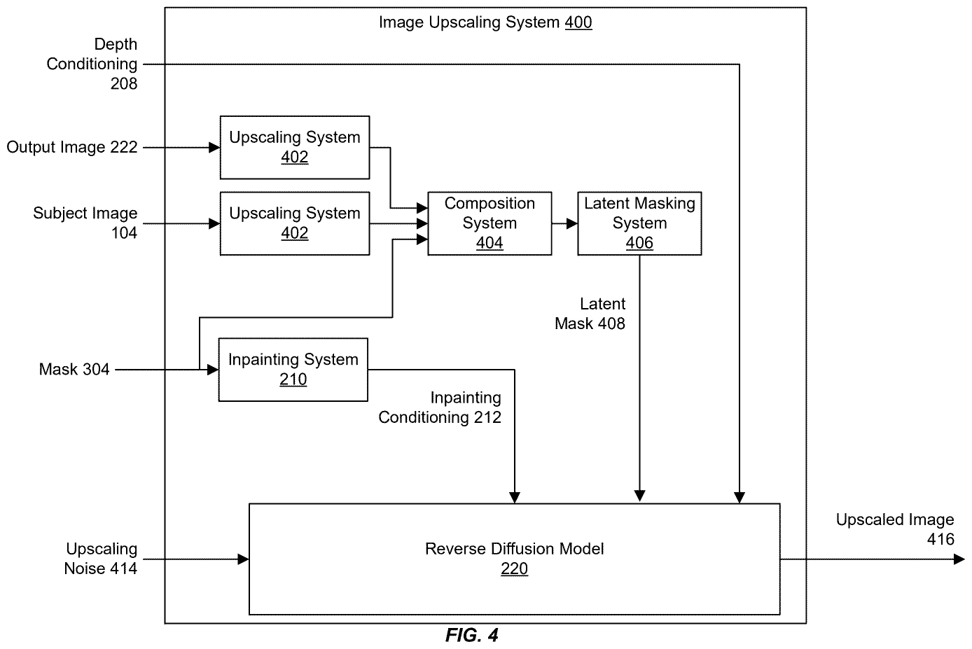

FIG. 4 is a block diagram illustrating an example image upscaling system 400, according to certain embodiments. The image upscaling system 400 may be used to upscale an image (e.g., output image 222 described above). The image upscaling system 400 may receive depth conditioning (e.g., depth conditioning 208 described above), an output image (e.g., output image 222 described above), a subject image (e.g., the subject image 104 described above), a mask (e.g., mask 304 described with respect to the second image generation system 300, the mask included in the subject image 104 received by the first image generation system 200), and/or upscaling noise 414 and use the inputs to generate an upscaled image 406. The image upscaling system 400 may include an upscaling system 402, a composition system 404, a latent masking system 406, an inpainting system 210, and/or a reverse diffusion model 220 (e.g., the reverse diffusion model 220 described above).

The depth conditioning 208 may be received from a depth network (e.g., depth network 206 described above). The depth conditioning 208 may be received from a first image generation system (e.g., first image generation system 200). Although the second image generation system 300 described above does not include a depth network, certain embodiments include a depth network that can generate depth conditioning 208 which can be transmitted to the image upscaling system 400. The depth conditioning 208 may be transmitted to the reverse diffusion model 220.

The upscaling system 402 may generate an upscaled image 416 based on an input image. In certain embodiments, the image received by the upscaling system 402 includes a one megapixel image. In certain embodiments, the image output by the upscaling system 402 includes a two megapixel image. In certain embodiments, the image output by the upscaling system 402 includes more (e.g., two times) the amount of pixels included in the image input to the upscaling system 402. The upscaling system 402 may include a set of machine learning models (e.g., an enhanced deep residual network) to perform the image upscaling. The upscaling system 402 may generate pixels to include in the image output from the upscaling system 402 based on the image input to the upscaling system 402. The upscaling system 402 may generate an upscaled output image based on the output image 222. The upscaling system 402 may generate an upscaled subject image based on the subject image 104 (without a mask overlaying the subject image).

The composition system 404 may receive the upscaled output image, the upscaled subject image (without a mask), and the mask 304. The composition system 404 may use the upscaled output image, the upscaled subject image (without a mask), and the mask 304 to generate a composite image representation. Using the inputs to the composition system 404, the composition system 404 can create a composite structure that allows for targeted post-processing operations by the image upscaling system 400. The mask 304 can enable subsequent image modifications (such as blending, color correction, and/or detail enhancement) to be confined to the relevant region(s), preventing unintended changes to other parts of the subject image 104. The original subject image 104 can be leveraged to maintain visual fidelity and to facilitate seamless transitions between the modified (garment-applied) region of the output image 222 and the surrounding unmodified areas from the subject image 104.

The composite structure generated by the composition system 404 may be transmitted to the latent masking system 406. The latent masking system 406 may transform pixel data of the composite structure and the mask 304 into a latent mask 408 representation. The latent mask 408 representation can enable more sophisticated manipulations, as changes in latent space can be more nuanced and globally consistent than direct pixel edits. The latent mask 408 may be transmitted to the reverse diffusion model 220 to be used to influence the generation of the upscaled image 416.

The inpainting system 210 may be the inpainting system 210 described above. The inpainting system 210 may generate inpainting conditioning 212 based on the mask 304. The inpainting conditioning 212 may be transmitted to the reverse diffusion model 220. The inpainting conditioning 212 may be used to influence the generation of the upscaled image 416.

The reverse diffusion model 220 may be the reverse diffusion model 220 described above with respect to first image generation system 200 and/or the second image generation system 300. The reverse diffusion model 220 may generate the upscaled image 416 based on inputs such as the depth conditioning 208, latent mask 408, the inpainting conditioning 212, and/or upscaling noise (e.g., noise 218 described above with respect to first image generation system 200 or another noise). The upscaling noise 414 may be generated using techniques like described above with respect to first image generation system 200. The upscaling noise 414 may be removed based on conditioning. The conditioning may include cross conditioning. The conditioning may rely on the depth conditioning 208, the latent mask 408 and/or the depth conditioning 208 to influence the generation of the upscaled image 416 from the upscaling noise 414.

In certain embodiments, a reverse diffusion model 220 is not used and instead a different type of machine learning model is used that can generate the upscaled image 416 based on inputs such as the depth conditioning, the latent mask 304, the inpainting conditioning 212, and/or the upscaling noise 414. In certain embodiments, the reverse diffusion model 220 generates an embedding of an image that can be decoded by a decoder model to generate the upscaled image 416.

The upscaled image 416 may represent the subject wearing the garment from a garment image (e.g., the garment image 102 described above). The upscaled image 416 may be represented using an image file format such as JPEG or PNG. The upscaled image 416 may be stored and/or transmitted. The upscaled image 416 may be the generated image 110 described above with respect to FIG. 1.

In certain embodiments, the upscaled image 416 is used for subsequent processing such as as input to the first image generation system 200 as a subject image 104, as input to the second image generation system 300 as subject image 104, as input to the image upscaling system 400 as subject image 104, and/or as input to the image upscaling system 400 as output image 222, etc.

### E. Reverse Diffusion Model

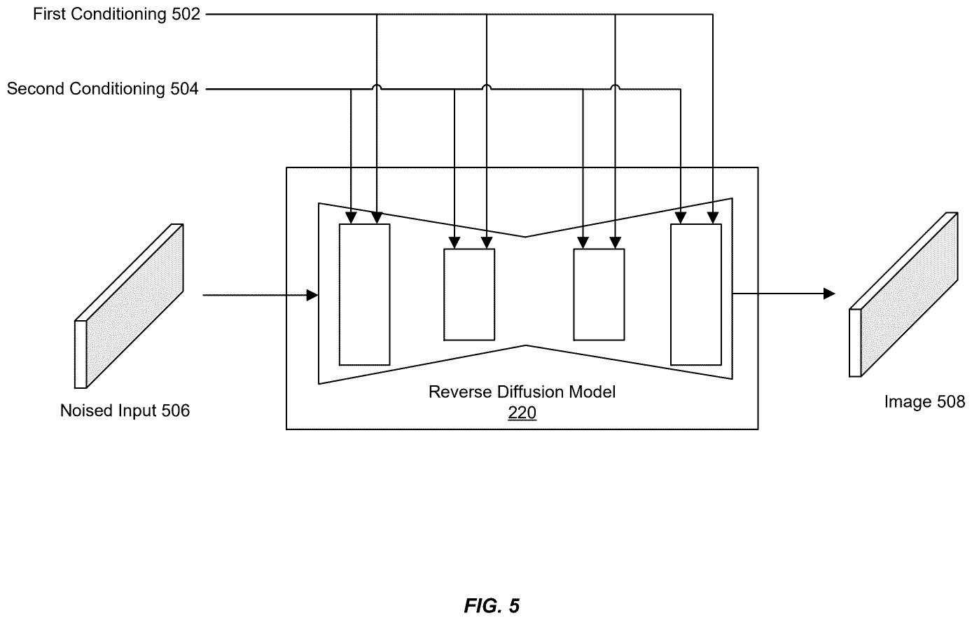

FIG. 5 is a block diagram illustrating an example reverse diffusion model 220 architecture, according to certain embodiments. The reverse diffusion model 220 may include a plurality of layers. The reverse diffusion model 220 may iteratively denoise noised input 506 to generate an image 508 (e.g., generated image 110, output image 222, upscaled image 416). The noised input 506 may be represented by a first embedding in vector space. The image 508 may be represented by a second embedding in vector space.

The reverse diffusion model 220 may receive conditioning (e.g., a set of one or more embeddings) that can be used to influence the generation of the image 508 from the noised input 506. The illustrated example shows a first conditioning 502 (e.g., image embedding 216 described above) and a second conditioning 504 (e.g., a prompt embedding such as a prompt embedding of prompt 106 described above). The set of embeddings may be used in any combination by the one or more layers of the reverse diffusion model 220. In certain embodiments, the same combination is used by each layer (e.g., as depicted by FIG. 5). In certain embodiments, different layers of the reverse diffusion model 220 use different combinations of embeddings.

In certain embodiments, the conditioning (e.g., first conditioning 502, the second conditioning 504, and/or other conditioning used) may include depth conditioning (e.g., depth conditioning 208), inpainting conditioning (e.g., inpainting conditioning 212), a prompt embedding (e.g., an embedding of prompt 106), an image embedding (e.g., image embedding 216), a mask (e.g., mask 304), and/or a latent mask (e.g., latent mask 408).

### I. Method

The processing performed using the inference system architecture described above with respect to FIGS. 1-4 may be implemented using a method of inference. An example of such a method is described below with respect to method 600.

The processing depicted in method 600 and any other FIGS. may be implemented in software (e.g., code, instructions, program) executed by one or more processing units (e.g., processors, cores) of the respective systems, using hardware, or combinations thereof. The software may be stored on a non-transitory storage medium (e.g., on a memory device). The method presented in method 600, and other FIGS. and described herein are intended to be illustrative and non-limiting. Although method 600, and other FIGS., depict the various processing steps occurring in a particular sequence or order, this is not intended to be limiting. In certain alternative embodiments, the processing may be performed in some different order or some steps may also be performed in parallel. It should be appreciated that in alternative embodiments the processing depicted in method 600, and other FIGS., may include a greater number or a lesser number of steps than those depicted in the respective FIGS.

### A. Inference Method

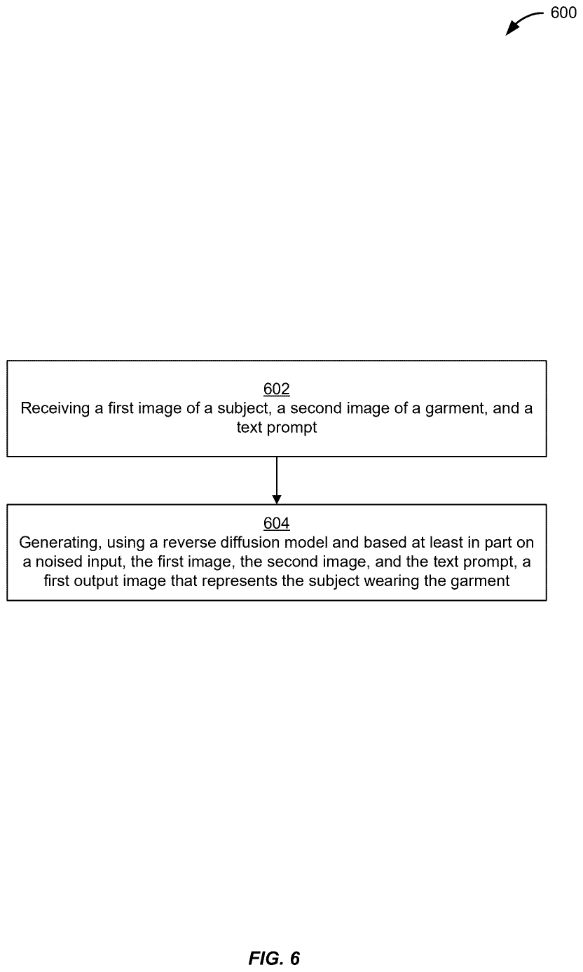

FIG. 6 shows an example method 600 of using a clothing visualization system (e.g., clothing visualization system 108 described above), according to certain embodiments of the present disclosure.

At S602, a first image may be received. The first image may include an image of a subject (e.g., subject image 104 described above in further detail). A second image may be received and may be of a garment (e.g., garment image 102 described above in further detail). A text prompt may be received (e.g., prompt 106 described above in further detail). The text prompt may describe a region of the first image. The text prompt may describe a region of the subject.

At S604, a reverse diffusion model may be used to generate based on (i) a noised input, (ii) the first image, (iii) the second image, (iv) and the text prompt, a first output image that represents the subject wearing the garment. The reverse diffusion model may generate an embedding of the first output image based at least in part on the noised input. A decoding model may be used to generate an image from the embedding of the first output image.

In certain embodiments, a depth map is generated based on inputting the first image into a depth estimation system (e.g., depth estimation system 202 described above). In certain embodiments, first conditioning (e.g., depth conditioning 208 described above) is generated based on the depth map. The depth map may be input to a neural network in the process of generating the first conditioning. In certain embodiments, the first output image is generated based on the first conditioning.

In certain embodiments, a mask is received. As described above, the mask may be included in the subject image 104, or provided separately (e.g., mask 304 from a segmentation system 302). The mask may indicate a portion of the first image. The reverse diffusion model may generate the first output image based on the mask (e.g., as input to the reverse diffusion model).

In certain embodiments, the mask is used to generate inpainting conditioning (e.g., inpainting conditioning 212 described above). The reverse diffusion model may generate the first output image based on the inpainting conditioning (e.g., used as cross conditioning).

In certain embodiments, an image embedding is generated based on the second image. The image embedding may be generated using an adapter system (e.g., adapter system 214 described above). The image embedding may be input to the reverse diffusion model to generate the first output image based on the image embedding. The image embedding may be input to the reverse diffusion model as cross conditioning. An embedding of the text prompt may be input to the reverse diffusion model. The embedding of the text prompt may be input to the reverse diffusion model as cross conditioning. The cross conditioning can cause (e.g., in combination with other inputs such as noise) the reverse diffusion model to generate the first output image.

In certain embodiments, a second output image is generated by inputting (i) the first output image, (ii) the mask to a second reverse diffusion model and/or the reverse diffusion model used to generate the first output image. The second reverse diffusion model may have the same model architecture, parameters, and/or parameter weights as the reverse diffusion model that generates the first output image. The second reverse diffusion model may be a instance of the model used to generate the first output image.

In certain embodiments, an image embedding is generated based on the second image. Inpainting conditioning and depth conditioning may be generated based on the first image. The first output image may be generated by inputting the image embedding, the inpainting conditioning, and the depth conditioning to the reverse diffusion model. The image embedding may be generated by inputting the second image to an adapter system that includes an image-prompt adapter including a neural network and that uses the second image to generate the image embedding. The inpainting conditioning may be generated by inputting the first image into the inpainting system that includes a neural network that uses the first image to generate the inpainting conditioning.

In certain embodiments, an image embedding (e.g., image embedding 216) is generated based at least in part on the second image. A mask (e.g., mask 304) may be generated based on the prompt and the first image. Inpainting conditioning (e.g., inpainting conditioning 212) based at least in part on the first image, the prompt, and the mask. The first output image may be generated based on inputting the image embedding, the inpainting conditioning, and/or the mask to the first reverse diffusion model. The mask may be generated based on inputting the prompt and the first image to a segmentation machine learning model.

In certain embodiments, depth conditioning may be generated based on the first image. Inpainting conditioning may be generated based on a mask (e.g., mask 304, a mask included in with first image). A latent mask (e.g., latent mask 408) may be generated based at least in part on the mask, the first image, and the first output image. A second output image may be generated by inputting the depth conditioning, the latent mask, and the inpainting conditioning to the reverse diffusion model. The second output image may include a higher resolution than the first output image and/or the first image. The depth conditioning, the latent mask, and the inpainting conditioning may be input to the reverse diffusion model as cross conditioning.

### II. Computer System

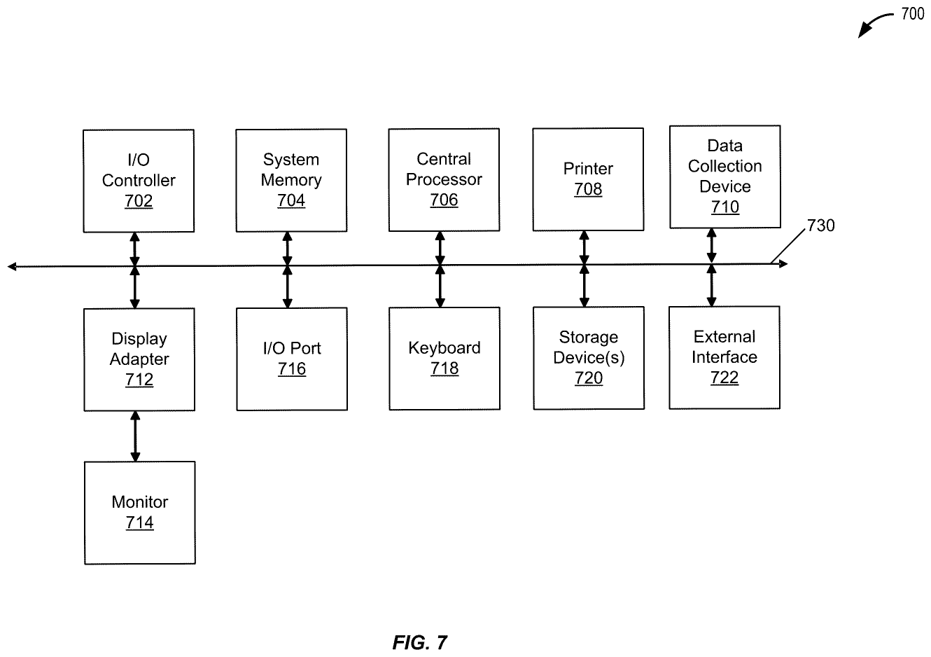

Any of the computer systems mentioned herein may utilize any suitable number of subsystems. Examples of such subsystems are shown in FIG. 7 in computer system 700. In some embodiments, a computer system includes a single computer apparatus, where the subsystems can be the components of the computer apparatus. In other embodiments, a computer system can include multiple computer apparatuses, each being a subsystem, with internal components. A computer system can include desktop and laptop computers, tablets, mobile phones and other mobile devices.

The subsystems shown in FIG. 7 are interconnected via a system bus 730. Additional subsystems such as a printer 708, keyboard 718, storage device(s) 720, monitor 714 (e.g., a display screen, such as an LED), which is coupled to display adapter 712, and others are shown. Peripherals and input/output (I/O) devices, which couple to I/O controller 702, can be connected to the computer system by any number of means known in the art such as input/output (I/O) port 716 (e.g., USB, FireWire®). For example, I/O port 716 or external interface 722 (e.g., Ethernet, Wi-Fi, etc.) can be used to connect computer system 700 to a wide area network such as the Internet, a mouse input device, or a scanner. The interconnection via system bus 730 allows the central processor 706 to communicate with each subsystem and to control the execution of a plurality of instructions from system memory 704 or the storage device(s) 720 (e.g., a fixed disk, such as a hard drive, or optical disk), as well as the exchange of information between subsystems. The system memory 704 and/or the storage device(s) 720 may embody a computer readable medium. Another subsystem is a data collection device 710, such as a camera, microphone, accelerometer, and the like. Any of the data mentioned herein can be output from one component to another component and can be output to the user.

A computer system can include a plurality of the same components or subsystems, e.g., connected together by external interface 722, by an internal interface, or via removable storage devices that can be connected and removed from one component to another component. In some embodiments, computer systems, subsystem, or apparatuses can communicate over a network. In such instances, one computer can be considered a client and another computer a server, where each can be part of a same computer system. A client and a server can each include multiple systems, subsystems, or components. In various embodiments, methods may involve various numbers of clients and/or servers, including at least 10, 20, 50, 100, 200, 500, 1,000, or 10,000 devices. Methods can include various numbers of communication messages between devices, including at least 100, 200, 500, 1,000, 10,000, 50,000, 100,000, 500,00, or one million communication messages. Such communications can involve at least 1 MB, 10 MB, 100 MB, 1 GB, 10 GB, or 100 GB of data.

Aspects of embodiments can be implemented in the form of control logic using hardware circuitry (e.g., an application specific integrated circuit or field programmable gate array) and/or using computer software stored in a memory with a generally programmable processor in a modular or integrated manner, and thus a processor can include memory storing software instructions that configure hardware circuitry, as well as an FPGA with configuration instructions or an ASIC. As used herein, a processor can include a single-core processor, multi-core processor on a same integrated chip, or multiple processing units on a single circuit board or networked, as well as dedicated hardware. The computations can be performed in parallel by the different processing units and/or different processing threads of a single processing unit. Based on the disclosure and teachings provided herein, a person of ordinary skill in the art will know and appreciate other ways and/or methods to implement embodiments of the present disclosure using hardware and a combination of hardware and software.

Any of the software components or functions described in this application may be implemented as software code to be executed by a processor using any suitable computer language such as, for example, Java, C, C++, C #, Objective-C, Swift, or scripting language such as Perl or Python using, for example, conventional or object-oriented techniques. The software code may be stored as a series of instructions or commands on a computer readable medium for storage and/or transmission, suitable media include random access memory (RAM), a read only memory (ROM), a magnetic medium such as a hard-drive or a floppy disk, or an optical medium such as a compact disk (CD) or DVD (digital versatile disk), flash memory, and the like. The computer readable medium may be any combination of such devices. In addition, the order of operations may be re-arranged. A process can be terminated when its operations are completed but could have additional steps not included in a figure. A process may correspond to a method, a function, a procedure, a subroutine, a subprogram, etc. When a process corresponds to a function, its termination may correspond to a return of the function to the calling function or the main function.

Such programs may also be encoded and transmitted using carrier signals adapted for transmission via wired, optical, and/or wireless networks conforming to a variety of protocols, including the Internet. As such, a computer readable medium according to an embodiment of the present invention may be created using a data signal encoded with such programs. Computer readable media encoded with the program code may be packaged with a compatible device or provided separately from other devices (e.g., via Internet download). Any such computer readable medium may reside on or within a single computer product (e.g., a hard drive, a CD, or an entire computer system), and may be present on or within different computer products within a system or network. A computer system may include a monitor, printer, or other suitable display for providing any of the results mentioned herein to a user.

Any of the methods described herein may be totally or partially performed with a computer system including one or more processors, which can be configured to perform the steps. Any operations performed with a processor may be performed in real-time. The term “real-time” may refer to computing operations or processes that are completed within a certain time constraint. As examples, a time constraint may be 30 seconds, 1 minute, 10 minutes, 30 minutes, 1 hour, 4 hours, 1 day, or 7 days. Thus, embodiments can be directed to computer systems configured to perform the steps of any of the methods described herein, potentially with different components performing a respective step or a respective group of steps. Although presented as numbered steps, steps of methods herein can be performed at a same time or at different times or in a different order. Additionally, portions of these steps may be used with portions of other steps from other methods. Also, all or portions of a step may be optional. Additionally, any of the steps of any of the methods can be performed with modules, units, circuits, or other means of a system for performing these steps.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention.

A recitation of “a”, “an” or “the” is intended to mean “one or more” unless specifically indicated to the contrary. The use of “or” is intended to mean an “inclusive or,” and not an “exclusive or” unless specifically indicated to the contrary. Reference to a “first” component does not necessarily require that a second component be provided. Moreover, reference to a “first” or a “second” component does not limit the referenced component to a particular location unless expressly stated. The term “based on” is intended to mean “based at least in part on.”

All patents, patent applications, publications, and descriptions mentioned herein are incorporated by reference in their entirety for all purposes. None is admitted as prior art. Where a conflict exists between the instant application and a reference provided herein, the instant application shall dominate.

What is claimed is:

1. A system comprising:
one or more storage media storing instructions; and
one or more processors configured to execute the instructions to cause the system to:
receive a first image of a subject, a second image of a garment, and a text prompt; and
generate, using a reverse diffusion model and based at least in part on a noised input, the first image, the second image, and the text prompt, a first output image that represents the subject wearing the garment, wherein the reverse diffusion model generates an embedding of the first output image based at least in part on the noised input.

2. The system of claim 1, wherein the text prompt describes a region of the first image.

3. The system of claim 1, wherein the text prompt describes a region of the subject.

4. The system of claim 1, wherein the processors are further configured to execute the instructions to cause the system to:
generate a depth map based at least in part on inputting the first image to a depth estimation system;
generate first conditioning based at least in part on inputting the depth map into a first neural network; and
generate the first output image based at least in part on the first conditioning.

5. The system of claim 1, wherein the processors are further configured to execute the instructions to cause the system to:
receive a mask indicating a portion of the first image; and
generate using the reverse diffusion model and based at least in part on the mask, the first output image.

6. The system of claim 5, wherein the processors are further configured to execute the instructions to cause the system to:
generate first conditioning based at least in part on the mask; and
generate using the reverse diffusion model and based at least in part on the first conditioning, the first output image.

7. A method comprising:
receiving a first image of a subject, a second image of a garment, and a text prompt; and
generating, using a reverse diffusion model and based at least in part on a noised input, the first image, the second image, and the text prompt, a first output image that represents the subject wearing the garment, wherein the reverse diffusion model generates an embedding of the first output image based at least in part on the noised input.

8. The method of claim 7, further comprising:
generating an image embedding based at least in part on the second image; and
generating inpainting conditioning and depth conditioning based at least in part on the first image; and
generating the first output image by inputting the image embedding, the inpainting conditioning, and the depth conditioning to the reverse diffusion model.

9. The method of claim 7, further comprising:
generating an image embedding based at least in part on the second image; and
generating a mask based at least in part on the text prompt and the first image;
generating inpainting conditioning based at least in part on the first image, the text prompt, and the mask; and
generating the first output image based at least in part on inputting the image embedding, the inpainting conditioning, and the mask to the reverse diffusion model.

10. The method of claim 9, further comprising:
generating the mask based at least in part on inputting the text prompt and the first image to a segmentation machine learning model.

11. The method of claim 7, further comprising:
generating depth conditioning based at least in part on the first image;
generating inpainting conditioning based at least in part on a mask;
generating a latent mask based at least in part on the mask, the first image, and the first output image; and
generating a second output image by inputting the depth conditioning, the latent mask, and the inpainting conditioning to the reverse diffusion model.

12. The method of claim 11, wherein the second output image includes a higher resolution than the first output image and the first image.

13. The method of claim 11, wherein the depth conditioning, the latent mask, and the inpainting conditioning are input to the reverse diffusion model as cross conditioning.

14. One or more non-transitory computer-readable storage media storing instructions that, upon execution by one or more processors of a system, cause the system to perform operations comprising:
receiving a first image of a subject, a second image of a garment, and a text prompt; and
generating, using a reverse diffusion model and based at least in part on a noised input, the first image, the second image, and the text prompt, a first output image that represents the subject wearing the garment, wherein the reverse diffusion model generates an embedding of the first output image based at least in part on the noised input.

15. The computer-readable storage media of claim 14, wherein the processors are further configured to execute the instructions to cause the system to perform operations comprising:
generating an image embedding based at least in part on the second image; and
generating using the reverse diffusion model and based at least in part on the image embedding, the first output image.

16. The computer-readable storage media of claim 15, wherein the image embedding is input to the reverse diffusion model as first cross conditioning and an embedding of the text prompt is input to the reverse diffusion model as second cross conditioning; and
wherein the first cross conditioning and the second cross conditioning cause the reverse diffusion model to generate the first output image.

17. The computer-readable storage media of claim 14, wherein the processors are further configured to execute the instructions to cause the system to perform operations comprising:
generating, a second output image by inputting (i) the first output image, (ii) a mask embedding generated based at least in part on the first image and the first output image to a second reverse diffusion model.

18. The computer-readable storage media of claim 14, wherein the processors are further configured to execute the instructions to cause the system to perform operations comprising:
generating an image embedding based at least in part on the second image; and
generating inpainting conditioning and depth conditioning based at least in part on the first image; and
generating the first output image by inputting the image embedding, the inpainting conditioning, and the depth conditioning to the reverse diffusion model.

19. The computer-readable storage media of claim 18, wherein the image embedding is generated by inputting the second image to an adapter system that includes an image-prompt adapter including a neural network and that uses the second image to generate the image embedding.

20. The computer-readable storage media of claim 18, wherein the inpainting conditioning is generated by inputting the first image into an inpainting system that includes a neural network that uses the first image to generate the inpainting conditioning.
